(19) United States
(12) Patent Application Publication
(10) Pub. No.: US 2021/0172716 A1
(43) Pub. Date: Jun. 10, 2021

(54) GUN VIDEO CAMERA SYSTEM

(71) Applicant: Check 6 Tactical & Training, LLC, Franklinton, NC (US)

(72) Inventors: Jason W. Myers, Franklinton, NC (US); Robert M. Christensen, Stuart, FL (US)

(73) Assignee: Check 6 Tactical & Training, LLC, Franklinton, NC (US)

(21) Appl. No.: 17/178,391

(22) Filed: Feb. 18, 2021

Related U.S. Application Data
(63) Continuation-in-part of application No. 16/941,118, filed on Jul. 28, 2020, now abandoned.
Application No. 16/941,118 is a continuation-in-part of application No. 16/052,079, filed on Aug. 1, 2018, now abandoned.
Application No. 16/052,079 is a continuation-in-part of application No. 15/425,309, filed on Feb. 6, 2017, now abandoned.

(51) Int. Cl. F41J 5/10; H04N 5/225; F41A 17/06; H04N 7/18

(52) U.S. Cl. CPC F41J 5/10; H04N 5/2252; H04N 7/181; F41A 17/06; H04N 5/2257

(57) ABSTRACT

A self-contained digitally tamper evident video camera system mounted on a tactile gun with a trigger guard and is housed in a universal tactile holster that records from the perspective of where the gun is pointed and utilizes a magnet to assist in automatically turning the video camera on and off with the capability to wirelessly transmit a recorded video.

This application is a continuation-in-part of U.S. non-provisional application Ser. No. 16/941,118 filed on Jul. 28, 2020, which is a continuation-in-part of U.S. non-provisional application Ser. No. 16/052,079 filed on Aug. 1, 2018, which is a continuation-in-part of U.S. non-provisional application Ser. No. 15/425,309 filed on Feb. 6, 2017 and are incorporated herein in their entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a camera system for use on a gun. In particular, it relates to a self-contained digitally tamper evident video camera system designed to be mounted on a gun, such as a hand gun with universal holster compatibility.

### Description of Related Art

The use of a gun in law enforcement is essentially universal to assist an officer in their duties, as well as protect the officer from potential injury or death. The presence of a gun means from time to time that the gun will be utilized with a suspect and that interaction can result in the suspect's injury or death. It has become increasingly of concern by the public that the use of a gun in such situations is not in keeping with the proper rights and safety of suspects, and increased scrutiny of such situations has increasingly occurred. In some instances, the use of body cams has attempted to provide evidence of such interactions, but the need to constantly record has left issues such as the length of battery operation for all-day video recording. A second problem is that a body cam is only as good as where the officer's body is pointed, which is not always where a gun is pointed. In addition, watch groups feel that some unscrupulous officers are tampering with the video footage as well as the video camera and accordingly, such video evidence is suspect, and in some cases non-existent.

The idea that a video camera could be attached to a gun means that the video camera records what the gun sees, regardless of what happens to the officer. Such video cameras attached to a gun have been around since at least 1936 and some grab both the top and bottom of the trigger guard, but the current video camera configurations have serious problems in addressing the fundamental situation. If just a video camera is mounted on the gun, nothing prevents the tampering of the video camera. The video can be easily erased. The video camera might have an on/off switch that can be forgotten about or turned off inappropriately. The video camera needs to point where the gun points, but in the heat of interacting with a suspect, the video camera can get misaligned even with something as simple as drawing the gun from its holster. The physical tampering of evidence is widespread and the current safeguards are often easy to get around or easy to replace.

### BRIEF SUMMARY OF THE INVENTION

The present invention relates to the use of a Hall effect sensor or a magnetic reed switch in the video camera on a gun, which is magnetically triggered upon removal of the gun from the holster, wherein the video camera has wing constraints that are positioned on either side of the front of the trigger guard to prevent movement of the video camera. It is designed to provide digitally tamper evident features that prevents the officer (or anyone else who is unauthorized) from being able to tamper with the video camera recordings.

Accordingly, in one embodiment, there is a self-contained digitally tamper evident video camera system for use on a tactical gun with a trigger guard surrounding a trigger and defines an open space for inserting a finger on a trigger and having a front, bottom, and back portion and is housed in a universal tactical holster, wherein the gun is designed for use in tactical situations, the self-contained digitally tamper evident video camera system consisting of:

a) a video camera;

b) a mounting bracket which removably attaches the video camera system to the tactical gun via a roll pin punch attachment;

c) a single on and off switch for the video camera consisting of a Hall effect sensor or a magnetic reed switch in the video camera system and a magnet on the universal tactile holster;

d) a battery to power the video camera;

e) a digitally tamper evident recordable medium in the video camera system for recording video;

f) wherein the digitally tamper evident recordable medium is contained in a case, and wherein the self-contained digitally tamper evident video camera system is positioned with wing constraints, which are positioned on either side of only the front of the trigger guard and positioned against the trigger guard without encroaching the space for inserting a finger to brace the housing from moving left or right;

g) wherein the system is designed of a size to fit in a universal tactical holster; and

h) wherein the self-contained digitally tamper evident video camera system has at least one feature selected from the group consisting of a microcontroller, a light guide, a light, a gauss strength measuring device, a power output, a charging port, a system that prevents firing of the gun unless the video camera is operating, encryption software, and night vision for the video camera.

### BRIEF DESCRIPTION OF THE DRAWINGS

FIG. 1 is a side view of the present invention showing the self-contained digitally tamper evident video camera system.

FIG. 2 is a perspective view of the present invention showing the self-contained digitally tamper evident video camera system.

FIG. 3 is a different perspective view of the present invention showing the self-contained digitally tamper evident video camera system.

FIG. 4 is a side view of the present invention showing the self-contained digitally tamper evident video camera system with the gun in a holster.

### DETAILED DESCRIPTION OF THE INVENTION

While this invention is susceptible to embodiment in many different forms, there is shown in the drawings and will herein be described in detail specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term “comprising” could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps or acts are in some way inherently mutually exclusive.

The drawings featured in the figures are for the purpose of illustrating certain convenient embodiments of the present invention and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, the term “video camera system” refers to a self-contained digital video camera system designed for attachment to a tactical gun used by an officer having a Weaver/Picatinny rail below the barrel on the tactical gun. The video camera system is designed to be digitally tamper evident to make it difficult for the officer (or anyone else who is unauthorized) to tamper with the starting and stopping of the video, as well as the recording process, (including what is being recorded) without evidence of such tampering. The use of encryption of the digital medium is an embodiment of this invention. This is done in order to protect the integrity of any evidence being collected by the video camera and to prevent an officer from turning the video camera off or disabling the video camera when their gun is in use. The video camera will have a battery to power the device and in some embodiments, it can have a charging port and a video download port. In one embodiment, the video camera includes audio recording. The camera will have a trigger guard surrounding the trigger and defining an opening to insert a finger and pull the trigger.

As used herein, the term “tactical gun” or “gun” refers to a gun having a trigger guard and is used preemptively, defensively, or operationally in a tactical situation, state, or setting, and the like, where a benefit can be attained by recording the activity from the gun's frontal view. Most all guns can be converted and/or applied as a tactical gun.

As used herein, the term “trigger guard” refers to a protective guard that surrounds the trigger, as shown in the Figures and defines a space for insertion of a finger to pull the trigger. Such trigger guards are standard and well known within the trade. They have a front portion, a bottom portion, and a back portion. The wings of the present invention are only positioned on either side of the front portion of the trigger guard, and not on the bottom or back portions, which helps to prevent interference with the trigger, they do not encroach into the space created for a finger, and they are positioned to prevent the video camera from moving left or right.

As used herein, the term “universal tactical holster” refers to a universal holster that is designed to receive a tactical gun and is designed to have a flashlight mounted on the Weaver/Picatinny rail since the video camera of the present invention is designed of roughly similar dimensions to be able to fit into such universal tactical holsters. In one embodiment, it is any device that holds the gun.

As used herein, the term “tactical situations” refers to a situation where an officer draws his tactical gun from its holster where the gun might be utilized.

As used herein, the term “video camera” refers to a digital camera having a lens designed to record to a memory device while the gun is in use or activated.

As used herein, the term “digitally tamper evident case” refers to any digital information, such as videos being encrypted or otherwise programmed, having the ability to detect all attempts to gain physical access to the video camera case or attempts to alter digital information.

As used herein, the term “mounting bracket” refers to a mounting bracket positioned on the top of the tamper evident case designed for removably attaching the video camera system to the Weaver/Picatinny rail of the gun. In one embodiment, it is attached to the gun using a roll pin punch in the mounted bracket.

As used herein, the term “mechanism for automatically turning the camera on” refers to a device in the video camera system, such that the video camera is turned on when the gun is removed from the holster and turns off when the gun is returned to the holster. The device is the only way to turn the video camera on or off and can be done so by any mechanical or electronic means such as infrared, wireless, mechanical switch, or the like. In one embodiment, the device is a Hall effect sensor or a magnetic reed switch which positions the video camera with a magnet that is positioned in the holster, such that removing the gun causes the magnet to pass by the Hall effect sensor or a magnetic reed switch, which turns the video camera on and then turns the video camera off when the gun is placed back in the holster. Since the video camera is positioned in front of the trigger guard and wings are located on either side of the front of the trigger guard, positioning the magnet or other device in the appropriate area of the holster is within the skill in the art in view of the disclosure herein.

As used herein, the term “battery” refers to a DC source to power the video camera's memory device for recording any microcontroller or other device detection associated with the video camera system, like a Wi-Fi or Bluetooth® wireless technology signal, cellular communications module, or the like, for sending the recording to a location different from the location of the gun. In one embodiment, sending the recording is automatic.

As used herein, the term “memory device” refers to a recordable digital memory or using a recording device to take the image/video from the video camera and record it on a digitally tamper evident recordable medium like a non-volatile memory card (e.g., multimedia cards, secure digital cards, data storage cards, etc.), or the like. As described above, any recorded image or video is encrypted (digitally tamper evident) to require specific software or hardware as a key to accessing the data.

As used herein, the term “wing constraints at the rear of the case” refers to the housing of the video camera system having a left and right wing being dovetail positioned at the rear of the case which are positioned on either side of only the front of the trigger guard, as shown in the Figures, and no place else. It does not encroach on the area to insert a finger, thus preventing the accidental firing of the gun. By positioning the constraints on either side of the front of the trigger guard, the casing cannot be moved from vertical orientation when struck, since otherwise the attachment to the rail might not be sufficient in preventing problems with both steadiness and video camera movement relative to the gun barrel. It also prevents interference with the trigger position at the bottom of the trigger guard. This represents a huge improvement in attachment of a video camera in terms of stability and safeguard, and especially for those which have wings that encroach on the area to insert a finger. In addition, having constraints only on the front of the trigger guard means the constraints will not interfere with gun use.

As used herein, the term “Hall effect sensor or a magnetic reed switch” refers to a transducer that varies its output voltage in response to a magnetic field. The Hall effect sensor or a magnetic reed switch is used for proximity switching of the video camera on and off when a magnet is placed in the holster in the appropriate position. In one embodiment, the system records the gauss strength of the magnet utilized so that one can tell if the magnet in the holster was utilized to turn the video camera on or off, or some other magnet of different gauss strength was used. Other sensors (e.g., reed switch and similar) can be used as well to activate the video camera upon removal from the holster, or the like.

As used herein, the term “microcontroller” refers to a computer present in a single integrated circuit, which is dedicated to perform a limited task and application. For example, coordinating the recording, fault protection, coordinating the Hall effect sensor or a magnetic reed switch, coordinating sending the video over Wi-Fi, cellular (e.g., LTE chip), Internet, or other wireless technology, and the like, as needed. The microcontroller functionality can also be embedded within the video camera recording device, though the transmitter may be separate from the microcontroller.

As used herein, the term “sent wirelessly” refers to having a wireless transmitter in the video camera system, which can take the video from the video camera in the housing and send it to a remote third location for processing in a manner to prevent tampering with the video. For example, the system could automatically open an incident report file and place the video taken by the video camera in that file, thus automatically creating the file necessary for reporting a particular incident by the officer having the gun drawn from the holster. In one embodiment, there is software in the case that encrypts the video as recorded and/or played back.

Optional attachments include a light or light guide, a power output, and the like powered by the video camera power source. Lights can be LED, night vision, or the like.

In one embodiment, the system is connected to the firing of the gun, such that the gun cannot be fired unless the video camera is operating. This would require the officer to keep the video camera charged and prevent the system from not working by just not charging the battery.

### DRAWINGS

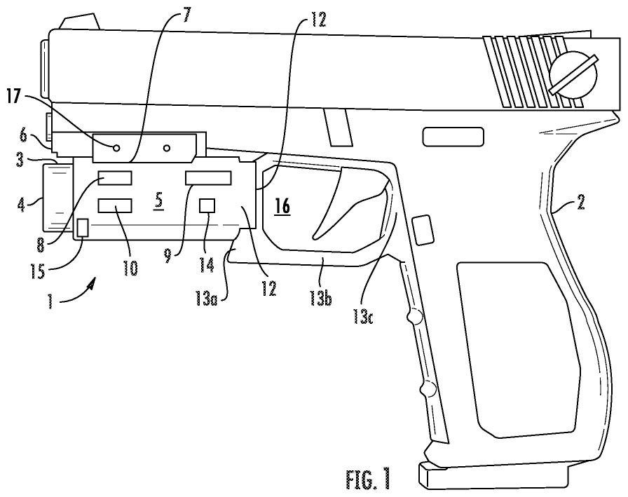

Now referring to the drawings, FIG. 1 is a side view of the self-contained digitally tamper evident video camera system 1 mounted on a handgun 2. While one gun type is drawn, others could be substituted. In this view, video camera 3 having a lens 4 protruding from the tamper evident case 5 is shown. The tamper evident case 5 is mounted to the Weaver/Picatinny rail 6 of handgun 2 by mounting bracket 7, which has a roll pin punch 17 in place on the rail and permanently affixed to the case. While any tamper evident device can be used, shown is tamper evident seal 15. Inside the case, is Hall effect sensor or a magnetic reed switch 8 for turning the video camera on and off, battery 9, and memory device 10 which includes a memory card (or other digital memory) and a recording device as described above. The case 5 has a wing constraint 12 on either side of the front of the trigger guard 13a (and not the bottom 13b or back 13c) to stabilize and brace the video camera against misalignment, use interference, and other issues. The wings do not enter the space for inserting a finger 16. Other devices 14 include Wi-Fi/Bluetooth®/cellular/Internet, etc. capabilities for sending video to a different location such as an incident case file, for measuring and recording gauss strength of the magnet used to turn the device on or off, for preventing the handgun from firing unless the video camera is operating, and the like.

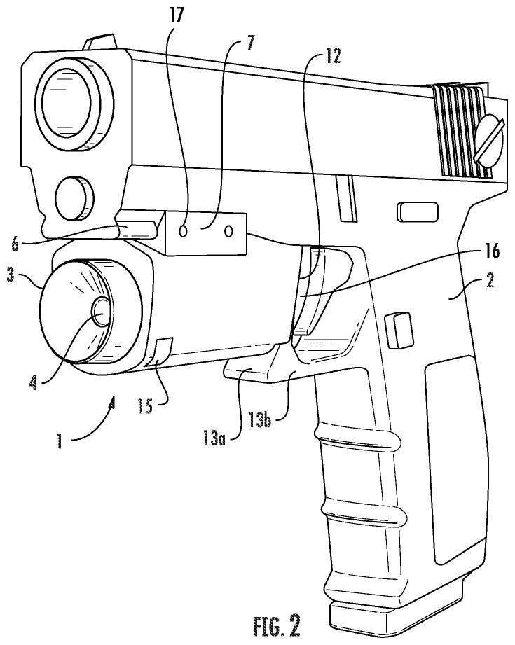

FIG. 2 is a perspective view showing the self-contained digitally tamper evident video camera system 1. This shows the same features, but some are clearer in this view than in a side view.

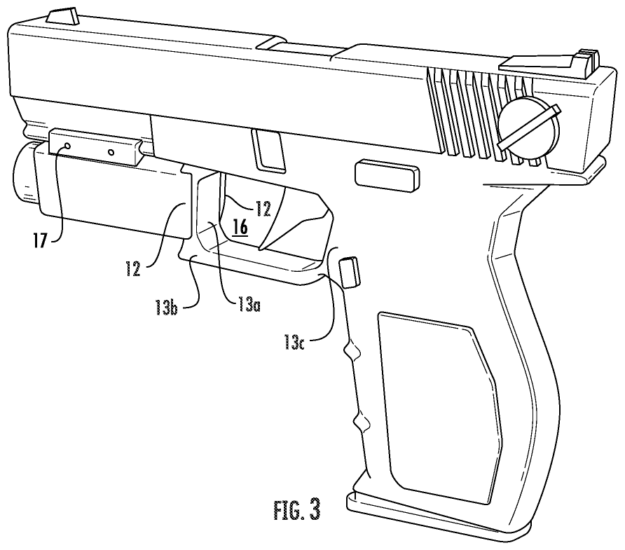

FIG. 3 is a different perspective view showing the self-contained digitally tamper evident video camera system.

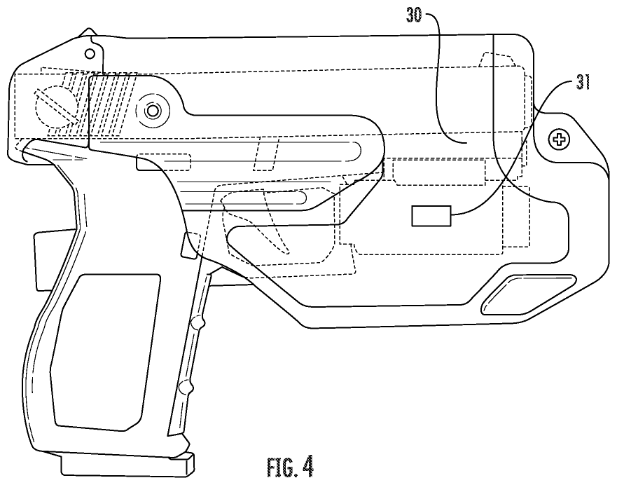

FIG. 4 is a side view of the self-contained digitally tamper evident video camera system and handgun sized to be positioned in a universal tactical holster 30 so that the gun does not need a special holster. In this view, self-contained digitally tamper evident video camera system 1 is hidden from view and is nestled next to magnet 31 of a selected gauss strength mounted in a universal holster to trigger a Hall effect sensor or a magnetic reed switch when the handgun is removed.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A self-contained digitally tamper evident video camera system for use on a tactical gun with a trigger guard surrounding a trigger and defines an open space for inserting a finger on a trigger and having a front, bottom, and back portion and is housed in a universal tactical holster, wherein the gun is designed for use in tactical situations, the self-contained digitally tamper evident video camera system consisting of:
a) a video camera;
b) a mounting bracket which removably attaches the video camera system to the tactical gun via a roll pin punch attachment;
c) a single on and off switch for the video camera consisting of a Hall effect sensor or a magnetic reed switch in the video camera system and a magnet on the universal tactile holster;
d) a battery to power the video camera;
e) a digitally tamper evident recordable medium in the video camera system for recording video;
f) wherein the digitally tamper evident recordable medium is contained in a case, and wherein the self-contained digitally tamper evident video camera system is positioned with wing constraints, which are positioned on either side of only the front of the trigger guard and positioned against the trigger guard without encroaching the space for inserting a finger to brace the housing from moving left or right;
g) wherein the system is designed of a size to fit in a universal tactile holster; and
h) wherein the self-contained digitally tamper evident video camera system has at least one feature selected from the group consisting of a microcontroller, a light guide, a light, a gauss strength measuring device, a power output, a charging port, a system that prevents firing of the gun unless the video camera is operating, encryption software, and night vision for the video camera.

2. The self-contained digitally tamper evident video camera system according to claim 1 wherein the mounting bracket is permanently affixed to the video camera.

3. The self-contained digitally tamper evident video camera system according to claim 1 wherein the mounting bracket attaches to a Weaver/Picatinny rail on the tactical gun.

4. The self-contained digitally tamper evident video camera system according to claim 1 wherein the wireless transmitter is a cellphone transmitter.

5. The self-contained digitally tamper evident video camera system according to claim 1 wherein the wireless transmitter is a Bluetooth® transmitter.

6. The self-contained digitally tamper evident video camera system according to claim 1 wherein the wireless transmitter is connected to the Internet.

7. The self-contained digitally tamper evident video camera system according to claim 1 which further comprises the case being tamper evident.
